(19) United States
(12) Patent Application Publication
(10) Pub. No.: US 2024/0012363 A1
(43) Pub. Date: Jan. 11, 2024

(54) Display device and method for displaying a timeline of at least two successive events and/or activities to be carried out

(71) Applicants: Manuel Nikodemus, Aachen (DE); Dirk Müller-Remus, Berlin (DE); Jan Schepers, Duisburg (DE); Christian Strieffler, Sommerloch (DE)

(72) Inventors: Manuel Nikodemus, Aachen (DE); Dirk Müller-Remus, Berlin (DE); Jan Schepers, Duisburg (DE); Christian Strieffler, Sommerloch (DE)

(21) Appl. No.: 18/038,467

(22) PCT Filed: Nov. 26, 2021
(86) PCT No.: PCT/EP2021/083122

§ 371 Date: May 24, 2023

(30) Foreign Application Priority Data
Nov. 30, 2020 (DE) 102020131601.1

(51) Int. Cl. G04G 9/00; G06F 3/04847

(52) U.S. Cl. CPC G04G 9/0064; G06F 3/04847; G06F 2203/04803

(57) ABSTRACT

The invention relates to a device (1-1f) for displaying a timeline of at least two successive events and/or activities to be carried out, said device having a main body (2-2e) with at least two display fields (4, 5, 6-4f, 5f, 6f) and a movable indicator (8-8c; 14; 14e; 14f).The movable indicator (8-8c; 14; 14e; 14f) is expediently designed to point to one of the display fields in order to indicate the event and/or the activity to be carried out. Advantageously, a user who is cognitively impaired is provided by the device according to the invention with an easily understandable time schedule independent of a time of day.

Furthermore, the invention relates to a method for displaying a timeline of at least two successive events and/or activities to be carried out, in which a movable indicator (8-8c; 14; 14e; 14f) points to one of at least two display fields (4, 5, 6-4f, 5f, 6f).

### CROSS REFERENCE TO RELATED APPLICATIONS

This application is the U.S. national stage of International Application No. PCT/EP2021/083122, filed on 2021-11-26. The international application claims the priority of DE 102020131601.1 filed on 2020-11-30; all applications are incorporated by reference herein in their entirety.

### BACKGROUND

The invention relates to a device for displaying a timeline of at least two successive events and/or activities to be carried out, said device having a main body with at least two display fields and a movable indicator.

DE 94 18 186.1 describes a mechanical children's watch with a single indicator in the form of an hour hand and a ring disc on which pictograms are applied. By rotating the ring disc, for example, a pictogram showing a TV set can be rotated to a specific time at which a child using the watch is allowed to watch TV. If the hour hand then points to this pictogram, the child knows that the upcoming activity is watching TV. With this children's clock, no duration of an event can be planned or indicated, only its beginning.

A mechanical children's watch is known from US 2015/0313388 A1, said watch having two display fields 3, 5 adjustable in size, of which a first 5 stands for a day time and another 3 for a night time. On the display field 5 standing for a daytime, pictograms 6, 7 can be applied, which pictograms stand for the start of activities at certain times of the day and to which pictograms a hand 20 can point. One revolution of the hand 20 (=360 degrees) corresponds to 24 h.

DE 94 13 324.7 describes a mechanical children's watch 1, which is designed as a wall or grandfather clock, and which has an adjustable ring 7 to which marking elements 4, 4″ can be detachably attached. Two marking elements 4 with pictograms are attached for recording time periods for activities, a first one representing a beginning and a second one representing an end of the time period.

US 2011/0193878 discloses a cell phone having an LCD display screen capable of displaying a clock 310 having display fields 330, each display field 330 representing an activity as well as an associated time period. Pointers are electronical and displayed on the LCD display screen of the cell phone.

A mechanical children's watch is known from DE 195 33 880 C1, which watch has a rim 2 with a metal ring 32 to which pictograms 10 indicating the beginning of a certain event at a certain time can be attached. Periods of time during which the activity is carried out are not known from DE 195 33 880 C1, only points in time.

DE 20 2014 009 333 U1 discloses a mechanical children's watch with a visual representation of time periods during which a certain activity is scheduled.

From KR 200168961 Y1, a scheduling device is known which can be designed as a grandfather clock and which has various display fields on a dial, which dials stand for various time periods in which certain activities indicated by pictograms are scheduled.

In the prior art, watches with a dial and at least two hands are known that indicate the time in hours and minutes.

People with cognitive disabilities often do not grasp the logic for reading a time and therefore rely on other methods to plan a timeline, such as a daily or weekly schedule.

### SUMMARY

The invention relates to a device (1-1f) for displaying a timeline of at least two successive events and/or activities to be carried out, said device having a main body (2-2e) with at least two display fields (4, 5, 6-4f, 5f, 6f) and a movable indicator (8-8c; 14; 14e; 14f).The movable indicator (8-8c; 14; 14e; 14f) is expediently designed to point to one of the display fields in order to indicate the event and/or the activity to be carried out. Advantageously, a user who is cognitively impaired is provided by the device according to the invention with an easily understandable time schedule independent of a time of day.

Furthermore, the invention relates to a method for displaying a timeline of at least two successive events and/or activities to be carried out, in which a movable indicator (8-8c; 14; 14e; 14f) points to one of at least two display fields (4, 5, 6-4f, 5f, 6f).

### DETAILED DESCRIPTION

The invention is based on the task of forming a device of the above-mentioned type, which enables a cognitively impaired person to plan time in a way that is easy to understand.

According to the invention, the task is solved in that the movable indicator is designed to point to one of the display fields to indicate the event and/or the activity to be carried out.

Each display field stands for a specific time period. In the simplest case, a first display field stands for a working day and a second display field for leisure time including night rest. For this purpose, the movable indicator points to the first display field during working hours and to the second display field during leisure time. To distinguish the adjacent display fields, these can have different colors or shapes. It is conceivable that the display fields have images such as symbols or pictograms that visually represent an event or an activity to be carried out.

The main body can also have different shapes, for example round, oval, triangular, square, hexagonal or octagonal. A different number of corners is conceivable. The display fields can be the same size or different sizes.

Preferably, the main body is formed from a renewable material, for example wood. It is conceivable that the main body is formed from another material such as steel, a light metal or a light metal alloy, plastic or glass.

A user who is cognitively impaired is advantageously provided by the device according to the invention with an easy-to-understand time schedule independent of a time in the known sense, in which time periods in which certain activities are scheduled can be recognized in a simple manner.

Further, the invention relates to a method for displaying a timeline of at least two successive events and/or activities to be carried out, in which a movable indicator points to one of at least two display fields.

It is convenient that each display field is assigned to a specific time period in which the event takes place and/or within which an activity carried out is to be completed. Advantageously, a user can recognize which event is about to take place and/or which activity to be carried out is scheduled. For example, if a display field forms a quarter of the viewing side, it is understood that a quarter of the total time must be spent on an event or the activity representing this display field.

In one embodiment of the invention, the display fields are variable in size. This makes it advantageously possible to adapt the time periods for which the display fields stand. A creation of an individualized time schedule, for example a daily schedule, is possible in a simple manner.

For this purpose, the display panels can, for example, be formed from colored, self-adhesive fabric or felt elements that are glued onto a main body. In the case of new planning, these can be detached and replaced by new ones that are larger or smaller.

In a further embodiment of the invention, the indicator is rod-shaped, preferably in the form of a pointer. A rod-shaped indicator can, for example, be designed in the manner of a rotating clock hand. Advantageously, a simple indication of an event or an activity to be carried out is possible. For example, one rotation of the hand by 360 degrees corresponds to an entire period of time in which all events and/or activities to be carried out fall and which may be between one hour and one year, in particular between 12 hours and 1 week. In particular, the total period is a whole day, i.e. 24 hours, a working day (for example 8 hours) or a night (circa 8 hours).

Expediently, a movement speed of the indicator is settable. Advantageously, time periods of different length can be planned with a single device. For example, the speed of movement of the indicator can be set in such a way that a complete daily schedule is planned. It is conceivable that the movement speed is set in such a way that a weekly or monthly schedule is displayed.

It is also conceivable that the speed of movement of the indicator can be varied from display field to display field. For example, particularly important activities or events can be represented by particularly large display fields.

Furthermore, it is conceivable that a movement speed varies from display field to display field. Advantageously, a merely small display field can be used for particularly long events and/or activities to be carried out.

It is possible to use a device according to the invention for production, vacation, seminar, workshop or retirement planning.

It is also conceivable to use a device according to the invention to display a cooking recipe as well as the necessary preparation steps.

In an embodiment of the invention, a signal means is provided, said signal means signalizing a transition of the indicator from one display field to an adjacent display field. The indicator can emit an acoustic, optical and/or haptic signal which indicates that another event is scheduled and/or another activity is now to be carried out. Advantageously, the device does not have to be viewed permanently.

An acoustic signal may be a warning tone or a sequence of tones, while a visual signal may be a flashing of at least one warning light, and a haptic signal may be a vibration of the main body.

Expediently, a separating line which separates adjacent display fields from one another is parallel to the movable indicator at a transition of the indicator from one display field to an adjacent display field. Advantageously, a distinct separation between adjacent display fields is possible, ambiguities as to whether an indicator points to a first or an adjacent second display field are advantageously prevented.

In a further embodiment of the invention, the main body has a visible side with visible side sections which are formed by the at least two display fields. Advantageously, all display fields can be seen immediately. Furthermore, it is possible to see which event or activity is about to take place.

The display fields can, for example, be formed as circle sectors and/or circle segments. Advantageously, a device is provided which is formed in the manner of a clock with an indicator which may be a hand. Such a device can be used, for example, for the simplified display of a schedule, for example a calendar of a manager.

In an embodiment of the invention, the main body has a visible side which formed by a matrix display. The matrix display can be applied to a visible side of the main body, for example glued on. Preferably, the matrix display is designed as an LCD, LED or OLED screen. Advantageously, the device can be individualized and used for various scheduling purposes. For this purpose, individual matrix display areas can form display fields whose size can be changed and which display specific colors, symbols or pictograms by means of control. Control can be effected by a control unit which is programmable, in particular remotely programmable, by an application program (“app”) which is executed on a computer, a cell phone or a tablet computer.

The main body can be designed as a carrier for the matrix display and can at least co-shape the optical design of the device, which can be designed in the manner of a pocket watch, wall watch, stand-up watch or wristwatch.

It is expedient that the matrix display is disc-shaped, in particular perforated disc-shaped, and preferably has a passage opening through which the indicator can pass through. Advantageously, a combination of a pointer, which forms an assembly of the device, and an electronic display is conceivable.

If the matrix display is designed in the form of a perforated disc, the indicator, which is mechanically designed, can pass through a passage opening, so that the indicator is arranged on a visible side of the device and a control device, which controls the indicator as well as its speed of movement, is arranged on a side facing away from the visible side.

It is particularly advantageous if the indicator is designed as a hand in the manner of a clock hand and the matrix display is circular in the manner of a clock dial with a passage opening in the center. A device is created which combines a mechanical indicator with a matrix display.

In a further embodiment of the invention, the movable indicator is designed as an electronic pointer which is displayed on the matrix display. Advantageously, an almost completely electronic device, preferably in the form of a wall clock, grandfather clock, pocket watch or wrist watch, is provided.

A display screen is expediently provided, said display screen is arranged at a distance from the display fields, preferably below. The display screen is designed in particular as an LCD screen and enables displaying supplementary information concerning the events or activities to be carried out. These can be in the form of text messages, pictograms, numbers, letters or colors.

It is conceivable that the display screen has several display areas.

In an embodiment of the invention, the device is designed in the manner of a grandfather clock, pocket watch, wall clock or wristwatch. The main body may form a housing or may be provided as a carrier for an electronic display such as a matrix display.

### BRIEF DESCRIPTION OF THE DRAWINGS

Embodiments of the invention are to be explained in more detail below on the basis of examples with reference to the non-limiting figures. It is shown:

FIG. 1 a first embodiment of a device according to the invention,

FIG. 2 another embodiment of a device according to the invention,

FIG. 3 of a third embodiment of a device according to the invention,

FIG. 4 a further embodiment of a device according to the invention,

FIG. 5 a fifth embodiment of a device according to the invention,

FIG. 6 a further embodiment of a device according to the invention,

FIG. 7 a particular embodiment of a device according to the invention.

### DETAILED DESCRIPTION OF THE PREFERRED EMBODIMENTS

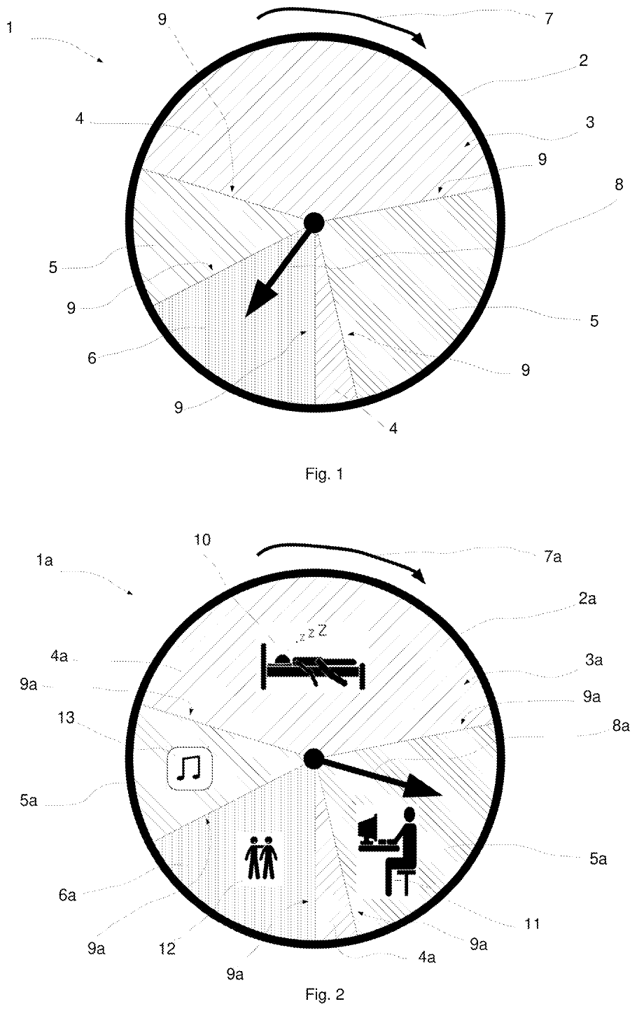

A device 1 shown in a top view in FIG. 1 is provided for planning a daily schedule of a person living with autism and comprises a round main body 2 which includes a plurality of adjacent display fields 4, 5, 6 forming circular sectors on a viewing side 3. Each of the display fields 4, 5, 6 is provided in color, with adjacent display fields 4, 5, 6 having different colors shown as hatched in FIG. 1. All display fields 4-6 are of different sizes, i.e. they have different surface areas.

An indicator which indicates an event and/or an activity to be carried out comprises a mechanical pointer 8 which is rotatable in the direction of an arrow 7 and which is rotatable by a drive not shown in FIG. 1, the drive being designed in such a way that in this embodiment a complete rotation of the pointer by 360 degrees corresponds to a whole day, i.e. 24 hours.

Each of the display fields 4-6 represents a time period that begins with the movement of the pointer 8 into the display field 4-6 and ends with the movement out of it into an adjacent display field 4-6. Throughout the period, an activity defined by the color of the display field 4-6 is to be carried out and/or an event defined by the color of the display field 4-6 occurs during the period. The pointer 8 indicates to a person using the device 1 what is to be done at what time. It is not necessary to resort to a clock known from prior art.

Adjacent display fields 4-6 are separated from each other by a separating line 9. The separating line 9 is parallel to the longitudinal axis of the pointer when it passes from one display field 4-6 to an adjacent display field 4-6.

In this embodiment, the pointer 8 points to a red indicator field 5, which represents the working day, while a green indicator field 6 represents night rest.

Reference is now made to FIG. 2, where identical or equal-acting parts are designated with the same reference number as in FIG. 1, and the letter a is added to the respective reference number.

A device 1a shown in a top view in FIG. 2 differs from that shown in FIG. 1 in that an exchangeable pictogram 10-13 is reusably applied to some of the display fields 4a-6a in addition to the color design.

Advantageously, a use is particularly intuitive.

For example, a pictogram 10 indicates that night rest is scheduled, while a pictogram 11 indicates a work period, a pictogram 12 indicates a social contact period, and a pictogram 13 indicates a period for leisure activities such as listening to music.

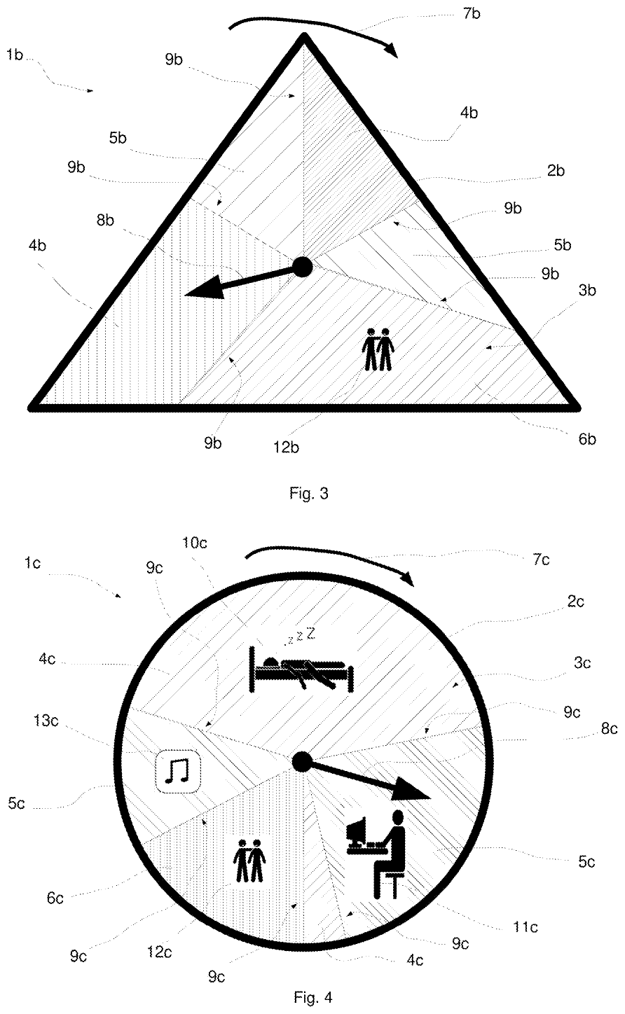

Reference is now made to FIG. 3, where identical or equal-acting parts are designated by the same reference number as in FIGS. 1 and 2, and the letter b is added to the respective reference number.

A device 1b shown in a top view in FIG. 3 differs from those shown in FIGS. 1 and 2 in that a main body 2b is triangular in shape and has display panels 4b-6b that are triangular or square in shape.

It is conceivable that the main body 2b has a different shape, for example square, pentagonal, hexagonal or octagonal.

Reference is now made to FIG. 4, where identical or equal-acting parts are designated by the same reference number as in FIGS. 1 to 3, and the letter c is added to the respective reference number.

A device 1c shown in a top view in FIG. 4 differs from those shown in FIGS. 1 to 3 in that a main body 2c is designed as a screen support for an LCD screen 3c, said screen support contributes to the design of the device 1d and is applied to a viewing side. Display panels 4c-6c form viewing surface sections of the LCD screen 3c.

A content to be displayed on the screen 3c is controllable by a control unit not shown in FIG. 4. The control unit is remotely programmable by a computer program executing, for example, as an application program (“app”) on a cell phone or tablet computer. A user of the device 1c can select a size, a color, and, if necessary, a pictogram in the computer program, thereby designing the content to be displayed on the LCD screen 3c and then transmitting it to the control unit for display on the LCD screen 3c, for example wirelessly via Bluetooth or WLAN. A speed at which a mechanical pointer 8c is moved is also settable.

In addition, it is possible to specify which period of time corresponds to a complete rotation of a pointer 8c by 360 degrees.

Conceivably, a single computer program can manage multiple devices 1c, each of which can be individualized.

The main body 26c is further designed in the shape of a perforated disk and has a through hole, not shown in FIG. 4, through which a connecting portion of the mechanical pointer 8c, which connects the pointer 8c to a drive not shown, is passed.

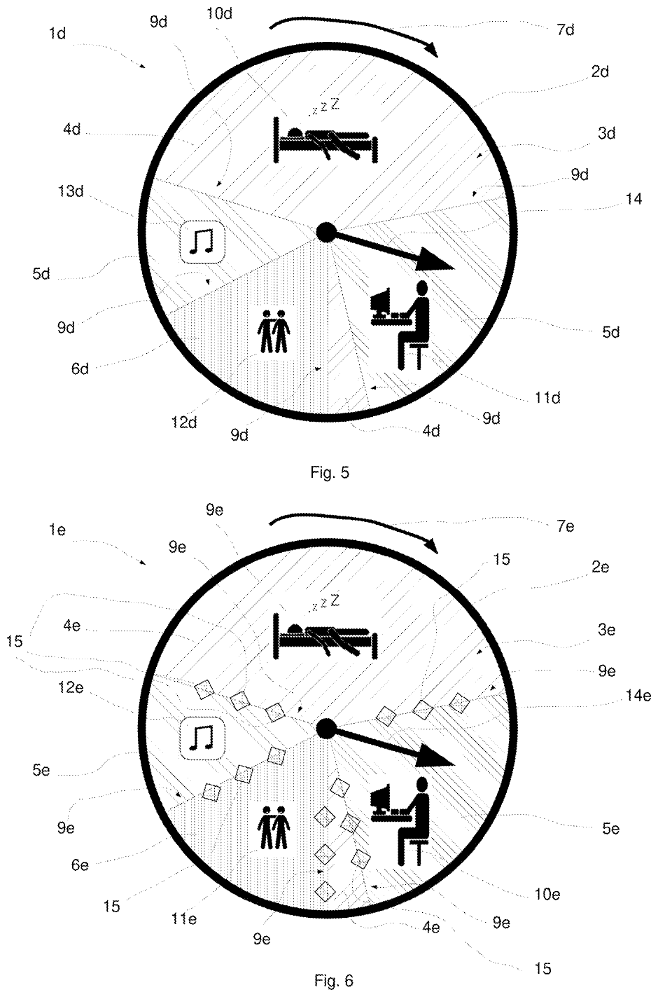

Reference is now made to FIG. 5, where identical or equal-acting parts are designated by the same reference number as in FIGS. 1 to 4, and the letter d is added to the respective reference number.

A device 1d shown in FIG. 5 in a top view differs from those shown in FIGS. 1 to 3 in that a main body 2d is designed as a screen support for an LCD screen 3d, said screen support contributes to the design of the device 1d and is applied to a visible side, and from FIG. 4 in that an electronic pointer 14 is provided that is generated by controlling the LCD screen 3a. Advantageously, no mechanical components are required, and customization of the device 1d to meet needs of a user is possible by using a computer program or an app executed on a cell phone.

Reference is now made to FIG. 6, where identical or equal-acting parts are designated by the same reference number as in FIGS. 1 to 5, and the letter e is added to the respective reference number.

A device 1e shown in FIG. 6 in a top view differs from those shown in FIGS. 1 to 5 in that during a transition from one display field 4e-6e to an adjacent display field 4e-6e three lights 15 are provided as optical signaling means, which lights are arranged along a separating line 9e and which light up three times during the transition of a pointer 14e from one display field 4e-6e to the adjacent display field 4e-6e. This signals to a user of the device le that a new event and/or a new activity to be carried out is scheduled.

It is understood that other signaling means are conceivable, for example a vibration of the device or of the main body 2e or an acoustic signal.

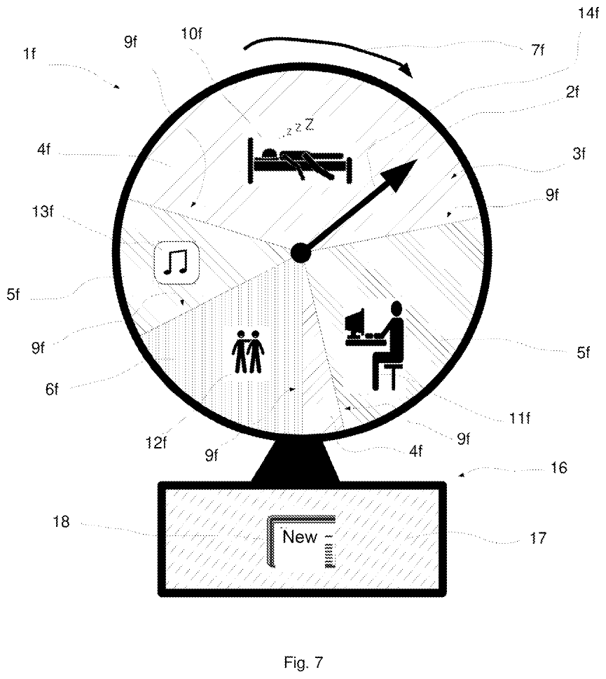

Reference is now made to FIG. 7, where identical or equal-acting parts are designated with the same reference number as in FIGS. 1 to 6, and the letter f is added to the respective reference number.

A device 1f shown in FIG. 7 in a top view differs from those shown in FIGS. 1 to 6 in that a main body has a lower portion 16 to which a separate display screen 17 is attached, said separate display screen is provided for displaying special, supplementary messages 18 concerning the events or activities to be carried out. These messages may be, for example, text messages.

It is conceivable that the device 1-1f is designed in the manner of a grandfather clock, pocket watch, wall clock or wristwatch.

It is understood that all combinations of the features shown in FIGS. 1 to 7 are conceivable. For example, a device 1b shown in FIG. 3 may have an LCD screen 3c as shown in FIG. 4, which is mounted on a main body 2c designed as a screen support.

1. A device (1-1f) for displaying a timeline of at least two successive events and/or activities to be carried out, said device having a main body (2-2f) with at least two display fields (4, 5, 6-4f, 5f, 6f) and a movable indicator (8-8c; 14; 14e; 14f)
characterized in that
the movable indicator (8-8c; 14; 14e; 14f) is designed to point to one of the display fields in order to indicate the event and/or the activity to be carried out.

2. The device according to claim 1,
characterized in that
the display fields (4, 5, 6-4f, 5f, 6f) are variable in size.

3. The device according to claim 1,
characterized in that
in that the indicator is rod-shaped, preferably in the form of a pointer (8-8f).

4. The device according to claim 1,
characterized in that
a movement speed of the indicator (8-8c; 14; 14e; 14f) is settable.

5. The device according to claim 1,
characterized in that
a signal means (15) is provided, said signal means signalizing a transition of the indicator (8-8c; 14; 14e; 14f) from one display field to an adjacent display field.

6. The device according to claim 1,
characterized in that
a separating line (9-9f) which separates adjacent display fields (4, 5, 6-4f, 5f, 6f) from one another is parallel to the movable indicator (8-8c; 14; 14e; 14f) at a transition of the indicator (8-8c; 14; 14e; 14f) from one display field to an adjacent display field.

7. The device according to claim 1,
characterized in that
the main body (2-2f) has a visible side (3-3f) with visible side sections which are formed by the at least two display fields (4, 5, 6-4f, 5f, 6f).

8. The device according to claim 1,
characterized in that
the main body (2-2f) has a visible side (3-3f) which is formed by a matrix display (3-3f).

9. The device according to claim 8,
characterized in that
the matrix display (3-3c) is disc-shaped, in particular perforated disc-shaped, and preferably has a passage opening through which the indicator (8-8c) can pass through.

10. The device according to claim 8,
characterized in that
the movable indicator (14; 14e; 14f) is designed as an electronic pointer which is displayed on the matrix display (3-3f).

11. The device according to claim 1,
characterized in that
a display screen (17) is provided, said display screen is arranged at a distance from the display fields (4, 5, 6-4f, 5f, 6f), preferably below.

12. The device according to claim 1,
characterized in that
the device (1-1f) is designed in manner of a grandfather clock, pocket watch, wall clock or wristwatch.

13. A method for displaying a timeline of at least two successive events and/or activities to be carried out, in which method a movable indicator (8-8c; 14; 14e; 14f) points to one of at least two display fields (4, 5, 6-4f, 5f, 6f),
characterized in that
each display field is assigned to a specific time period in which the event takes place and/or within which an activity carried out is to be completed.

14. The method according to claim 13,
characterized in that
in the event of a transition of the indicator (8-8c; 14; 14e; 14) from one display field (4, 5, 6-4f, 5f, 6f) to an adjacent display field (4, 5, 6-4f, 5f, 6f), a visual, acoustic and/or haptic signal (15) is output, which signals a new event or another activity to be carried out to a user.

15. The method according to claim 13,
characterized in that
the event and/or the activity to be carried out is displayed visually, in particular as a symbol or a pictogram (10-13; 10e-13f), in at least one of the display fields (4, 5, 6-4fe, 5f, 6f).
